(19) United States
(12) Patent Application Publication
(10) Pub. No.: US 2012/0141652 A1
(43) Pub. Date: Jun. 7, 2012

(54) DRIED KONJAC AND MANUFACTURING METHOD THEREFOR AS WELL AS PROCESSED FOODS USING SAID DRIED KONJAC

(75) Inventors: Kazuo Watanabe, Aichi (JP); Mikio Kato, Aichi (JP); Keishi Fukuda, Hiroshima (JP)

(73) Assignee: ABS INC., Aichi (JP)

(21) Appl. No.: 13/390,501

(22) PCT Filed: Oct. 7, 2009
(86) PCT No.: PCT/JP2009/067513

§ 371 Date: Feb. 14, 2012

(51) Int. Cl. A23L 1/214; A23L 1/308

(52) U.S. Cl. 426/640

(57) ABSTRACT

Provided are dried konjac having the contradictory elements of improved water-reconstitution properties and an effect to prevent degeneration when dried along with reduced calories and sugars and which can be anticipated to have blood sugar-suppressing effects, a manufacturing method therefor, and processed foods using said dried konjac.

The dried konjac is characterized in that it comprises, by weight ratio, 8-20% of one or more kinds of starch material selected from tapioca, potato, cornstarch, and processed starch, 6-20% konjac powder, 15-40% of one or more kinds of dietary fiber material selected from a dietary fiber material A group including digestion-resistant starch and processed starch comprising a large quantity of dietary fiber, 0-10% of one or more kinds of dietary fiber material selected from a dietary fiber material B group comprising oat fiber, wheat fiber, potato fiber, sugarcane fiber, crystalline cellulose, sodium alginate, carrageenan, guar gum, hydrolyzed guar gum, psyllium seed gum, xanthan gum, tamarind gum, tragacanth gum, and Gellan gum, and 30-50% of digestion-resistant dextrin.

### TECHNICAL FIELD

The present invention relates to dried konjac capable of suppressing a blood sugar level, having low calorie and low sugar contents, and capable of being reconstituted with water; a manufacturing method therefor; and processed foods using the dried konjac.

### BACKGROUND ART

As represented by metabolic syndrome, lifestyle-related diseases such as diabetes have become a serious issue and the number of diabetic patients in Japan including potential ones is said to reach 20 million. Control of obesity, which is one of the causes of diabetes, has becoming a national problem to be overcome. There is therefore an increasing demand for foods with a low calorie content and a reduced sugar content. At present, diabetic patients cannot satisfy their appetite because rice and noodles serving as staple foods, confectionaries, and fruits raise a blood sugar level. There is therefore a demand for the development of low-calorie and low-sugar foods which diabetic patients can take deliciously while following a restrictive diet, that is, a calorie restricted diet or sugar restricted diet.

In accordance with the Nutrition Labeling Standards established by the Ministry of Health, Labor and Welfare, foods with a “low calorie” or “low sugar” statement have not greater than 40 kcal or contain not greater than 5 g of sugars, each per 100 g food, respectively.

Dried konjac is originally a food taken after reconstituted with water and konjac products to be used after reconstitution with water to from 2.5 to 5 times the original weight have been put on the market.

The terms “low calorie” and “low sugar” used in connection with the dried konjac or processed food thereof according to the present invention mean that the calorie content and sugar content of the konjac or processed food thereof after reconstituted with water are lower than those of conventional products.

Konjac has been long rated high as a low-calorie food material and frequent use of it in eating habits can contribute to the control of diet. Commercially available konjac has however been used in limited recipes such as oden and sukiyaki because of its unique odor and difficulty in flavoring. On the other hand, dried konjac has been put on the market as that improved in odor and flavoring, but it contains a starch or malt syrup in order to prevent degradation of it by drying. In the above dried konjac, konjac itself has a low calorie content, but the product becomes a high-calorie food due to the starch or malt syrup which has increased its sugar content. In the end, the product becomes a cause for raising a blood sugar level (Patent Document 1: Japanese Patent No. 3159104).

With respect to a water reconstitution technique of dried konjac, invented is a method of obtaining dried konjac with a good texture and good water reconstitution properties by treating it with a dietary fiber degrading enzyme or hypochlorous acid to weaken its tissue, soaking it in a malt syrup to prevent degradation due to drying, and then drying (Patent Document 2: Japanese Patent Laid-Open No. 2007-222017 and Patent Document 3: Japanese Patent Laid-Open No. 10-248515).

In the technologies disclosed in Patent Documents 2 and 3, however, it is necessary to develop a material serving as an alternative for the malt syrup having a high calorie content and rich in sugars and to improve the texture and water reconstitution properties properly while considering both the calorie and sugar contents.

It has been announced by reports that indigestible dextrin has both low calorie and low sugar contents and has a blood sugar level suppressing effect. On the other hand, it is water soluble, has a low viscosity, and adversely affects the texture or quality of many foods with an increase in its content so that a method of mixing it with a thickening polysaccharide or the like to prepare a water-soluble dietary-fiber containing composition and adding the composition to food is invented (Patent Document 4: Japanese Patent Laid-Open No. 2006-254901).

The manufacturing method of Patent Document 4 however requires much labor and time and in addition, such a composition cannot be added freely to konjac which should be soaked in water. Thus, when it is used, an appropriate addition method is necessary.

A konjac-powder-containing rice-like dried product has conventionally been put on the market. It has 249 kcal and contains 59.25 g of sugars, each per 100 g. It is taken after reconstitution with water to 5 times the original weight so that upon eating, the reconstituted product has 49.8 kcal and contains 1.85 g of sugars. This product is only a konjac-powder-containing food and is not konjac itself.

### RELATED ART DOCUMENTS

### Patent Documents

Patent Document 1: Japanese Patent No. 3159104
Patent Document 2: Japanese Patent Laid-Open No. 2007-222017
Patent Document 3: Japanese Patent Laid-Open No. Hei
Patent Document 4: Japanese Patent Laid-Open No. 2006-254901

### SUMMARY OF THE INVENTION

### Problems to be Solved by the Invention

Dried konjac is originally a food taken after reconstituted with water.

As described above, dried konjac contains, in addition to konjac powder, a starch material and a malt syrup. The starch material is used for increasing a water reconstitution ratio, absorbing much water during water reconstitution.

With an increase in the water reconstitution ratio, the dried konjac expands more and contents of its components become smaller by dilution. The starch material exerts a great effect for it.

The malt syrup is used to prevent deterioration of physical properties of konjac when it is dried and it is, even after reconstitution with water, effective for providing a substantially similar texture to that before drying.

On the other hand, the starch material and malt syrup have high calorie and high sugar contents. Dried konjac absorbed much water due to the effect of the starch material and malt syrup so that even after it was reconstituted, it had high calorie and high sugar contents.

Even if a low-calorie and low-sugar material is used instead of the starch material in order to reduce the calorie and sugar contents of dry konjac, the calorie and sugar contents of konjac after reconstitution with water cannot be reduced due to a decrease in a water reconstitution ratio.

Even when indigestible dextrin having low calorie and low sugar contents and said to be effective for suppressing a blood sugar level was used instead of the malt syrup, it had a viscosity lower than that of the malt syrup so that it ran off during a processing step. It was therefore impossible to incorporate the indigestible dextrin in the dried konjac in an amount sufficient for exhibiting an expected function and an expected effect for preventing degeneration which would otherwise occur due to drying.

It was therefore necessary to find an adequate mixing proportion and establish a manufacturing method using it in order to obtain dried konjac having two contradictory factors, that is, improved water-reconstitution properties and an effect of preventing degeneration caused by drying and reduced calorie and sugar contents.

Konjac has conventionally been used only in some foods because of its unique odor, texture bringing a feeling of strangeness, and difficulty in allowing seasonings to be absorbed. In dried konjac improved from such standpoints, however, starch materials and sugars such as malt syrup incorporated in the improved dried konjac have become a cause of an increase in calorie and sugar contents of it.

For example, rice-like dried konjac put on the market has 344 kcal and contains 81.6 g of sugars, each per 100 g. It is taken after re-constituted with water to 5 times the original weight so that when it is taken, the calorie is 68.8 kcal and a sugar content is 16.32 g.

A konjac-powder-containing rice-like dried food has also been put on the market. It has 249 kcal and contains 59.25 g of sugars, each per 100 g. It is taken after reconstituted with water to 5 times the original weight so that when it is taken, the calorie is 49.8 kcal and a sugar content is 11.85 g. It is a food containing konjac powder and is not konjac itself, though having lower calorie and lower sugar contents than dried konjac.

The starch material and malt syrup to be incorporated in dried konjac are used in order to alleviate the peculiar texture of konjac, improve water absorption when it is reconstituted with water, and improve water reconstitution properties when it is reconstituted with water, but it is preferable to reduce the use thereof as much as possible in order to avoid the increase of the calorie and sugar contents.

As food materials substitutable for the starch material, dietary fiber materials having low calorie and sugar contents and dispersible in and swellable with water are desirable, but the kind and mixing proportion of it should be considered to avoid it from affecting the texture.

Dietary fiber materials to be used for forming a konjac dough into a desired shape are preferably selected from a dietary fiber material group A including indigestible starches and processed starches rich in dietary fibers. The dietary fiber material selected from the group A may be used in combination with one or more dietary fiber materials selected from a dietary fiber material group B including oat fibers, wheat fibers, potato fibers, sugarcane fibers, crystalline cellulose, sodium alginate, carrageenan, guar gum, hydrolyzed guar gum, Psyllium seed gum, xanthan gum, tamarind gum, tragacanth gum, and Gellan gum having low calorie and sugar contents and use in combination with the dietary fiber material group A. The dietary fiber material group B however has an influence on the texture, taste, and water reconstitution properties compared with the dietary fiber material group A so that a smaller amount of it is better.

The digestible dextrin is used to prevent degradation of konjac which will otherwise occur due to drying. It has calorie and sugar contents lower than those of the starch material and malt syrup and is expected to have a blood sugar level suppressing effect, but has a disadvantage that since it is a water soluble dietary fiber, it runs off when added during formation of a konjac dough into a desired shape.

An object of the present invention is to overcome the problem of dried konjac required to satisfy two contradictory factors, that is, an effect of improving water reconstitution properties and preventing degeneration of dried konjac caused by drying and reduction in calorie and sugar contents and to provide dried konjac expected to have a blood sugar level suppressing effect, a manufacturing method thereof, and a processed food using the dried konjac.

### Means for Solving the Problems

Dried konjac according to the present invention is characterized by that it contains, ratio by weight, from 8 to 20% of at least one starch material selected from tapioca, potato, corn starch, and processed starch, from 6 to 20% of konjac powder, from 15 to 40% of at least one dietary fiber material selected from a dietary fiber material group A including indigestible starches and processed starches rich in dietary fibers, from 0 to 10% of at least one dietary fiber material selected from a dietary fiber material group B including oat fiber, wheat fiber, potato fiber, sugarcane fiber, crystalline cellulose, sodium alginate, carrageenan, guar gum, hydrolyzed guar gum, psyllium seed gum, xanthan gum, tamarind gum, tragacanth gum, and Gellan gum, and from 30 to 50% of indigestible dextrin.

A method of manufacturing died konjac according to the present invention is characterized by that it is equipped with a step of preparing a konjac starch by using from 1.6 to 4.0% of a starch material, from 1.2 to 4.0% of konjac powder, from 3.0 to 10.0% of a dietary fiber material, and from 82.0 to 94.2% of water, a step of gelling the konjac starch while adjusting the water temperature to not greater than the gelatinization temperature of the starch, that is, not greater than 60° C., a step of steaming the konjac gel at 70° C. or greater and gelatinizing the starch in the konjac gel in a water unsaturated state without increasing a water content of the konjac gel, and a step of adding from 5 to 20%, based on the konjac gel, of indigestible dextrin to the konjac gel and mixing to discharge the water from the konjac gel.

A processed food using the dried konjac as described in claim 1 is characterized by that it is a rice-like food containing the component as described in claim 1.

A processed food using the dried konjac as described in claim 1 is characterized by that it is a noodle-like food containing the component as described in claim 1.

A processed food using the dried konjac as described in claim 1 is characterized by that it is obtained by adding a granular or powdery ground product having, as one component thereof, the dried konjac as described in claim 1.

A processed food using the dried konjac as described in claim 1 is characterized by that it is an instant food having, as one component thereof, the dried konjac as described in claim 1.

A processed food using the dried konjac as described in claim 1 is characterized by that it is a retort food having, as one component thereof, the dried konjac as described in claim 1.

The konjac powder serving as a raw material of dried konjac having reduced calorie and sugar contents is obtained by thinly slicing and drying Amorphophallus konjac belonging to konjac genus of the Araceae family containing glucomannan or obtained by separating it in the presence of hydrous alcohol and then drying.

As the starch material to be mixed with the konjac powder in order to improve water absorption and control the texture, at least one material is selected from tapioca, potato, corn starch, and processed starch.

It is necessary to adjust the content of the starch material to at least 8% in order to gelatinize the konjac gel to incorporate much indigestible dextrin and expect reduction in the calorie and sugar contents after reconstitution with water. The content is more preferably 13% or greater. Since the starch material contains sugars in an amount as high as 0.994 g per 100 g, the amount of sugars contained in the starch material is, at a maximum, 19.88 g corresponding to a sugar content of 20% in consideration of sugars of other materials used for the dried konjac.

With regard to the content of konjac powder, the content of less than 6% leads to a poor retention property, while when the content exceeds 20%, the texture peculiar to konjac becomes excessive. Contents within a range of from 10 to 14% are more preferred.

The konjac gel is impregnated with indigestible dextrin. In consideration of water reconstitution properties, the upper limit of the content of the indigestible dextrin is 50%. From the standpoints of function, efficacy, and reduction in calorie and sugar contents, the indigestible dextrin is incorporated preferably in an amount of 30% or greater.

The amount of the dietary fiber material to be used in forming the konjac gel may be determined from low calorie and low sugar contents found based on the contents of the starch material, konjac powder, and indigestible dextrin and assuming that the dried konjac is reconstituted with water to from 3 to 5 times the original weight. It is desired to select at least one dietary fiber material from the dietary fiber material group A, but the dietary fiber material of the group A may be used in combination with at least one dietary fiber material selected from the group B having less calorie and sugar contents. The dietary fiber materials belonging to the group B affect particularly the texture, taste, and water reconstitution properties of the dried konjac so that the upper limit of its content is 10%, more preferably 5% or less.

In order to incorporate a greater amount of indigestible dextrin from which reduction in sugar and calorie contents and a blood sugar level suppressing effect can be expected, a konjac gelation step and an indigestible dextrin impregnation step are important.

What is most important in the konjac gelation step is to control the water temperature to not greater than the gelatinization temperature of starch, more specifically, 60° C. or less and thereby preventing gelatinization of the starch material in the sol.

By preventing gelatinization of the starch material, water absorption of the starch material can be inhibited, making it possible to efficiently impregnate the konjac gel with the indigestible dextrin and efficiently dry the gel, which are steps conducted after the gelation step.

It has been confirmed that without gelatinization of the starch, the shape of the konjac can be kept sufficiently only by gelation and in addition, only a small amount of starch grains is leaked into water during the gelation step.

Rightly after gelatinization of the starch material in the konjac gel, the konjac gel is impregnated with indigestible dextrin. It is conducted in the following manner.

The starch in the konjac is gelatinized by steaming the konjac gel to the gelatinization temperature of the starch or greater, more specifically, 70° C. or greater with steam.

At this time, there is almost no difference in the water content in the konjac gel before and after the gelatinization of the starch.

When the starch material in the konjac is gelatinized in hot water as in the typical konjac manufacture, water absorption occurs due to the gelatinization of the starch material. As a result, so-called water swelling occurs.

Next, indigestible dextrin is added to the konjac gel and they are mixed.

At this time, the indigestible dextrin penetrates into the konjac gel based on the principle of osmotic pressure and water in the konjac gel runs off outside the gel.

This step is performed until an indigestible dextrin concentration reaches equilibrium between the konjac gel and the run-off water.

Water which has run off from the konjac gel penetrates into the konjac gel again by the absorbing action of the starch material.

Konjac processed products having good water reconstitution properties, improved in texture which is originally peculiar to konjac and brings a feeling of strangeness, and having reduced calorie and sugar contents can be obtained by drying the konjac gel containing much indigestible dextrin based on the above-described principle.

### Advantage of the Invention

The dried konjac according to the present invention contains, by weight, from 8 to 20% of at least one starch material selected from the starch materials, from 6 to 20% of konjac powder, from 15 to 40% of at least one dietary fiber material selected from the dietary fiber material group A, from 0 to 10% of at least one dietary fiber material selected from the dietary fiber material group B, and from 30 to 50% of indigestible dextrin so that it is expected to suppress a blood sugar level as a low calorie and low sugar food material and can be used as a food for preventing obesity and diabetes which have been increasing year by year or as a food for diabetic patients.

In addition, the present invention makes it possible to provide dried konjac having good water reconstitution properties, improved in strange texture which is peculiar to konjac, having a low calorie content, and having a reduced sugar content.

In the manufacturing method of dried konjac according to the present invention, since the starch material is prevented from gelatinization to suppress water absorption of the starch material, it is possible to efficiently impregnate the konjac gel with indigestible dextrin, which is a step conducted thereafter, and efficiently dry the resulting gel. In addition, without gelatinization of the starch, the konjac can hold its shape only by gelation of the konjac so that only a slight amount of starch grains run off into water in the gelation step.

Further, in the manufacturing method of dried konjac according to the present invention, the konjac gel containing much indigestible dextrin is dried, which makes it possible to provide dried konjac having good water reconstitution properties, improved in strange texture peculiar to konjac, having a low calorie content, and having a reduced content of sugars.

Still further, in the manufacturing method of dried konjac according to the present invention, the step of impregnating the konjac gel with indigestible dextrin is effective for discharging water of the konjac gel outside thereof. Described specifically, when the konjac gel is impregnated with indigestible dextrin, the indigestible dextrin present on the surface of the konjac gel penetrates into the konjac gel by the osmotic pressure and water in the konjac gel is replaced by the indigestible dextrin to go outside. This phenomenon continues until the concentrations of the indigestible dextrin inside and outside the konjac gel reach equilibrium.

When the starch contained in the konjac gel has been gelatinized in a water saturated state, an aqueous solution of the indigestible dextrin is present outside the konjac gel at the time of completion of the impregnation with the indigestible dextrin. This aqueous solution is recovered for recycling use or discarded so that it should be borne in mind that this inevitably leads to an economical loss.

The manufacturing method of dried konjac according to the present invention is on the other hand based on the concept that by gelatinizing the starch contained in the konjac gel in a water unsaturated state, water which has run off upon completion of the impregnation of the indigestible dextrin is returned into the konjac gel by the use of the water absorption power of the starch.

In addition, the manufacturing method of the dried konjac according to the present invention is effective in the drying step. Described specifically, by preventing gelatinization of the starch during gelation of konjac, water absorption of the starch is suppressed to the minimum necessary level to make the drying of the gel, which is a step conducted thereafter, significantly easy. In the drying step, the konjac gel is dried with hot air of from about 90 to 100° C. until its water content reaches about 10%. It is needless to say that as the water content of the konjac gel before drying is lower, the drying can be conducted more efficiently.

### MODE FOR CARRYING OUT THE INVENTION

The manufacturing steps of dried konjac in the present invention will next be described.

Among the manufacturing steps, the gelation step of konjac and the impregnation step of indigestible dextrin are important.

What is most important in the gelation step is not to gelatinize the starch material in the gel by controlling the water temperature to not greater than the gelatinization temperature of the starch, more specifically, not greater than 60° C.

By preventing gelatinization of the starch material, it is possible to suppress water absorption of the starch material and thereby efficiently impregnate the konjac gel with indigestible dextrin, which is a step conduced thereafter, and efficiently dry the gel.

It has been confirmed that without gelatinization of the starch, only the gelation is sufficiently effective for shape retention and a very slight amount of starch grains runs off into water during the gelation step.

Rightly after the gelatinization of the starch material in the gelled konjac, the impregnation step with indigestible dextrin is carried out.

The following is a specific manufacturing method of dried konjac.

The konjac gel is heated to the gelatinization temperature of the starch or greater, more specifically, steamed at 70° C. or greater with steam to gelatinize the starch in the konjac.

At this time, there is almost no difference in the water content in the konjac gel before and after gelatinization of the starch.

When the starch material in the konjac is gelatinized in hot water as in the conventional konjac manufacture, the gelatinization of the starch material is accompanied with water absorption and so-called water swelling occurs.

Next, indigestible dextrin is added to the konjac gel and they are mixed.

At this time, the indigestible dextrin penetrates into the konjac gel based on the principle of osmotic pressure and water in the konjac gel runs off from the gel.

This step is continued until the indigestible dextrin concentration in the konjac gel and that in the run-off water reach equilibrium.

The run-off water from the konjac gel is absorbed again in the konjac gel by the absorbing action of the starch material.

Based on the above-described principle, by drying the konjac gel impregnated with much indigestible dextrin, dried konjac having good water reconstitution properties, improved in strange texture peculiar to konjac, having a low calorie content, and having a reduced sugar content can be obtained.

The contents of main materials to be used for the dried konjac of the present invention and measures of their calories and sugar contents are shown in Table 1.

TABLE 1

| Materials | Content (%) | Calorie (kcal) | Sugars (g) |
|---|---|---|---|
| Konjac powder | 6 to 20 | 11.3 to 37.7 | 0.34 to 1.14 |
| Starch material | 8 to 20 | | |
| Tapioca starch | | 32.3 to 80.6 | 7.95 to 19.88 |
| Processed starch | | 32 to 80 | 7.95 to 19.88 |
| Dietary fiber with less | 15 to 40 | | |
| run-off (dietary fiber | | | |
| material group A) | | | |
| Indigestible starch | | 38.6 to 102.8 | 3.84 to 10.24 |
| Processed starch rich | 0 to 10 | 30.5 to 81.2 | 0.51 to 1.36 |
| in dietary fiber (dietary | | | |
| fiber material group B*) | | | |
| Oat fiber | | 0 to 0.63 | 0 to 0.11 |
| Crystalline cellulose | | 0 | 0 to 0.03 |
| Tamarind gum | | 0 to 20.25 | 0 |
| preparation | | | |
| Gellan gum preparation | | 0 to 1.88 | 0 |
| Psyllium seed gum | | 0 to 0.63 | 0 |
| Indigestible dextrin | 30 to 50 | 34.7 to 57.9 | 1.59 to 2.65 |
| Water | 8 to 12 | 0 | 0 |

*It is desired that as the dietary fiber with less run-off, at least one material is selected from the dietary fiber material group A, but at least one material selected from the dietary fiber material group B having less calorie and less sugar contents may be used in combination with the dietary fiber material group A. It is however to be noted that the dietary fiber material group B has an influence on the texture, taste, and water reconstitution properties so that its amount is preferably smaller.

### Example 1

The dried konjac of the present invention was obtained in Example 1 based on the data of content, calories, and sugars shown in Table 2-1.

TABLE 2-1

| Materials used | Content (%) | Calorie (kcal) | sugars (g) |
|---|---|---|---|
| Konjac powder | 11.84 | 22.29 | 0.67 |
| Tapioca starch | 18.95 | 76.41 | 18.84 |
| Processed starch rich | 23.69 | 48.09 | 0.81 |
| in dietary fibers | | | |
| Indigestible dextrin | 35.5 | 41.11 | 1.88 |
| Water | 10.02 | 0 | 0 |
| Total | | 187.9 | 22.2 |

The manufacturing method of dried konjac shown in Example 1 will next be described.

(Manufacturing Steps of Rice-Like Konjac Gel)

Rice-like konjac is prepared by the conventional method from a mixture of 2.5% (by weight) of konjac powder, 4% of tapioca starch, 5% of processed starch rich in dietary fibers, and 88.5% of water. Described specifically, a predetermined amount of water is added to a mixture of konjac powder, a starch material, and a dietary fiber material and the resulting mixture is dispersed and dissolved. After the resulting mixture is allowed to stand at room temperature, the mixture is stirred and kneaded while adding lime powder thereto. The kneaded mass is formed into granules having a diameter of from 3 to 5 mm by means of a rotary nozzle of a konjac granulator. The resulting granules are poured in hot water of 60° C., followed by stirring for 10 minutes to obtain a rice-like konjac gel.

What is most important in the gelation step is not to gelatinize the starch material in the sol by suppressing the water temperature to not greater than the gelatinization temperature of the starch, more specifically, not greater than 60° C.

By preventing gelatinization of the starch material and thereby suppressing the starch material from absorbing water, it is possible to efficiently impregnate the konjac gel with the indigestible dextrin, which is a step conducted thereafter, and efficiently dry the resulting gel.

(Manufacturing Steps of Noodle-Like Konjac Gel)

Noodle-like konjac is prepared by the conventional method from a mixture of 2.5% (by weight) of konjac powder, 4% of tapioca starch, 5% of processed starch rich in dietary fibers, and 88.5% of water. Described specifically, a predetermined amount of water is added to a mixture of konjac powder, a starch material, and a dietary fiber material and the resulting mixture is dispersed and dissolved. After the resulting mixture is allowed to stand at room temperature, the mixture is stirred and kneaded while adding lime milk thereto. The konjac powder kneaded mass is extruded into noodles from a rectangular nozzle hole having a length of from 1.0 to 2.0 mm and a width of from 2.0 to 4.0 mm. The noodles thus obtained by extrusion are poured in hot water of 60° C., stirred for 10 minutes to cure them, and cut into a predetermined size to obtain konjac gel in the form of flat noodles.

What is most important in the gelation step is not to gelatinize the starch material in the gel by suppressing the water temperature to not greater than the gelatinization temperature of the starch, more specifically, to not greater than 60° C.

By preventing gelatinization of the starch material and thereby suppressing the starch material from absorbing water, it is possible to efficiently impregnate the konjac gel with the indigestible dextrin, which is a step conducted thereafter, and efficiently dry the resulting gel.

(Weakening Treatment Step)

The tissue of each of the rice-like or noodle-like konjac manufactured in the above steps is weakened.

After the rice-like or noodle-like konjac is neutralized with a citric acid solution, it is dipped in an aqueous hypochlorous acid solution having an effective chlorine concentration of 50 ppm at 35° C. for 20 minutes.

Alternatively, a dietary fiber degrading enzyme may be used. In this case, it is recommended to add a solution of dietary fiber degrading enzyme such as hemicellulase to the rice-like or noodle-like konjac neutralized with citric acid and stir the resulting mixture to impregnate the konjac.

(Indigestible Dextrin Adding Step)

The konjac gel thus weakened is then drained and heated to 70° C. or greater with steam under stirring to gelatinize the starch material. Rightly after heating, indigestible dextrin is added and the mixture is stirred to impregnate the konjac gel with 10% of water-soluble dietary fibers.

At this time, the indigestible dextrin penetrates into the konjac gel based on the principle of osmotic pressure and water in the konjac gel runs off from the gel.

This step is continued until the indigestible dextrin concentration in the konjac gel and that in the run-off water come to equilibrium.

The water which has run off from the konjac gel is absorbed again into the konjac gel by the absorbing action of the starch material.

The indigestible dextrin reduces the calorie and sugar contents and at the same time, prevents degeneration of konjac due to drying.

(Drying Step)

The resulting gel is dried with hot air at 90° C. to yield dried konjac.

(Grinding and Sifting Step: in the Case of Granular/Powdery Konjac)

The dried konjac obtained by hot air drying is then ground in a pin mill, followed by sifting through a stainless sieve. Sifting through a 60-mesh sieve yields granular konjac, while sifting through a 100-mesh sieve yields powdery konjac.

### Example 2

In Example 2, dried konjac of the present invention was obtained using the materials at the contents as shown in Table 2-2.

The dried konjac can be obtained in a similar manner to that employed in Example 1 except for the using materials and their contents.

TABLE 2-2

| Materials used | Content (%) | Calorie (kcal) | sugars (g) |
|---|---|---|---|
| Konjac powder | 11.0 | 20.71 | 0.63 |
| Tapioca starch | 20.0 | 80.64 | 19.88 |
| Processed starch rich | 20.0 | 40.6 | 0.68 |
| in dietary fibers | | | |
| Indigestible dextrin | 34.0 | 39.37 | 1.8 |
| Crystalline cellulose | 5.00 | 0 | 0.02 |
| Water | 10.0 | 0 | 0 |
| Total | | 181.32 | 23.01 |

### Example 3

In Example 3, dried konjac of the present invention using the materials at the contents as shown in Table 2-3 were obtained.

The manufacturing method of it is similar to that employed in Example 1 except for the using materials and their contents.

TABLE 2-3

| Materials used | Content (%) | Calorie (kcal) | Sugars (g) |
|---|---|---|---|
| Konjac powder | 11.5 | 21.65 | 0.66 |
| Processed starch | 13.5 | 54.0 | 13.42 |
| Processed starch rich | 30.0 | 60.9 | 1.02 |
| in dietary fibers | | | |
| Indigestible dextrin | 30.0 | 34.74 | 1.59 |
| Crystalline cellulose | 5.00 | 0 | 0.02 |
| Water | 10.00 | 0 | 0 |
| Total | | 171.29 | 16.71 |

### Example 4

In Example 4, dried konjac of the present invention using the materials at the contents as shown in Table 2-4 were obtained.

The manufacturing method of it is similar to that employed in Example 1 except for the using materials and their contents.

TABLE 2-4

| Materials used | Content (%) | Calorie (kcal) | Sugars (g) |
|---|---|---|---|
| Konjac powder | 10.0 | 18.83 | 0.57 |
| Processed starch | 15.0 | 60.0 | 14.91 |
| Processed starch rich | 20.0 | 40.6 | 0.68 |
| in dietary fibers | | | |
| Indigestible dextrin | 45.0 | 52.11 | 2.39 |
| Water | 10.0 | 0 | 0 |
| Total | | 171.54 | 18.55 |

With respect to the dried konjac obtained in each of Examples 1 through 4, the relationship among water reconstitution ratio and calorie, sugar content, and indigestible dextrin content after reconstitution with water is as shown in Table 3.

The dried konjac is a food taken after reconstituted with water. The dried konjac obtained in Example 1 became 4 times the original weight and the calorie and sugar weight per 100 g became 46.98 kcal and 5.55 g, respectively. The dried konjac obtained in Example 2 became 4 times the original weight and the calorie and sugar weight per 100 g became 45.33 kcal and 5.75 g, respectively. The dried konjac obtained in Example 3 became 3.5 times the original weight and the calorie and sugar weight per 100 g became 48.94 kcal and 4.77 g, respectively. The dried konjac obtained in Example 4 became 3.5 times the original weight and the calorie and sugar weight per 100 g became 49.01 kcal and 5.3 g, respectively. The results suggest that the dried konjac of each of Examples 1 through 4 reconstituted with water has a low calorie content and a low sugar content.

TABLE 3

| | After | | | |
|---|---|---|---|---|
| Compo- | reconsti- | Calorie/ | Sugars/ | Indigestible |
| sition | tution | 100 g | 100 g | dextrin |
| No. | (times) | (kcal) | (g) | content (g) |
| Example 1 | 4 | 46.98 | 5.55 | 8.88 |
| Example 2 | 4 | 45.33 | 5.75 | 8.5 |
| Example 3 | 3.5 | 48.94 | 4.77 | 8.57 |
| Example 4 | 3.5 | 49.01 | 5.3 | 12.86 |

Comparison between the dried konjac of the present invention reconstituted with water and paddy rice/well milled rice, steamed Chinese noodles, commercially available rice-like dried konjac (after reconstitution with water) (Referential Example 1), and commercially available konjac powder-containing rice-like product (after reconstitution with water) (Referential Example 2) is shown in Table 4.

Comparison in energy and sugar content (reduction rate) between the dried konjac of Examples 1 through 4 reconstituted with water and paddy rice/well milled rice, steamed Chinese noodles, commercially available rice-like dried konjac (after reconstitution with water), and commercially available konjac powder-containing rice-like product (after reconstitution with water) is shown in Table 4.

TABLE 4

| | Paddy rice/well milled rice | | Steamed Chinese noodles | |
|---|---|---|---|---|
| | Calorie | Sugar content | Calorie | Sugar content |
| | (168 kcal/100 g) | (35.8 g/100 g) | (198 kcal/100 g) | (36.5 g/100 g) |
| Example 1 | 27.96% | 15.50% | 23.73% | 15.21% |
| Example 2 | 26.98% | 16.06% | 22.89% | 15.75% |
| Example 3 | 29.13% | 13.32% | 24.72% | 13.07% |
| Example 4 | 29.17% | 14.80% | 24.75% | 14.52% |
| | | | Commercially available konjac powder- | |
| | Commercially available rice-like dried | | containing rice-like product | |
| | konjac (Referential Example 1) | | (Referential Example 2) | |
| | Calorie | Sugar content | Calorie | Sugar content |
| | (68.8 kcal/100 g) | (16.32 g/100 g) | (49.8 kcal/100 g) | (11.85 g/100 g) |
| Example 1 | 68.28% | 34.01% | 94.34% | 46.84% |
| Example 2 | 65.89% | 35.23% | 91.02% | 48.52% |
| Example 3 | 71.13% | 29.23% | 98.27% | 40.25% |
| Example 4 | 71.24% | 32.48% | 98.41% | 44.73% |

The invention product in rice form can be used as an alternative of paddy rice/well milled rice. According to STANDARD TABLES OF FOOD COMPOSITION IN JAPAN, Fifth Revised and Enlarged Edition, the calorie and weight of sugars of paddy rice/well milled rice are 168 kcal and 35.8 g, respectively, per 100 g. The weight of sugars is determined by subtracting the total weight of dietary fibers from the weight of carbohydrates.

The dried konjac of Example 1 has a calorie of 187.9 kcal and contains 22.2 g of sugars as shown in Table 2-1. After reconstitution with water to 4 times the original amount as shown in Example 1 of Table 3, the dried konjac has a calorie of 46.98 kcal and contains 5.55 g of sugars, each per 100 g. This has revealed that the calorie and weight of sugars of the dried konjac reconstituted with water decrease to 27.96% and 15.5% of those of typical paddy rice/well milled rice, respectively.

The dried konjac obtained in Example 2 has a calorie of 181.32 kcal and contains 23.01 g of sugars as shown in Table 2-2. After reconstitution with water to 4 times the original weight as shown in Example 2 of Table 3, the dried konjac has a calorie of 45.33 kcal and contains 5.75 g of sugars, each per 100 g. This has revealed that the calorie and weight of sugars decrease to 26.98% and 16.06% of those of the typical paddy rice/well milled rice, respectively.

The dried konjac obtained in Example 3 has a calorie of 171.29 kcal and contains 16.71 g of sugars as shown in Table 2-3. After reconstitution with water to 3.5 times the original weight as shown in Example 3 of Table 3, the dried konjac has a calorie of 48.94 kcal and contains 4.77 g of sugars, each per 100 g. This has revealed that the calorie and weight of sugars decrease to 29.13% and 13.32% of those of the typical paddy rice/well milled rice, respectively.

The dried konjac obtained in Example 4 has a calorie of 171.54 kcal and contains 18.55 g of sugars as shown in Table 2-4. After reconstitution with water to 3.5 times the original weight as shown in Example 4 of Table 3, the dried konjac has a calorie of 49.01 kcal and contains 5.3 g of sugars, each per 100 g. This has revealed that the calorie and the weight of sugars decrease to 29.17% and 14.8% of those of the typical paddy rice/well milled rice, respectively.

The processed product of the present invention in string (noodle) form can be used as an alternative of ramen, udon, or pasta. According to STANDARD TABLES OF FOOD COMPOSITION IN JAPAN, Fifth Revised and Enlarged Edition, steamed Chinese noodles have a calorie of 198 kcal and contain 36.5 g of sugars, each per 100 g.

The dried konjac obtained in Example 1 has a calorie of 187.9 kcal and contains 22.2 g of sugars as shown in Table 2-1. After reconstitution with water to 4 times the original weight as shown in Example 1 of Table 3, the dried konjac has a calorie of 46.98 kcal and contains 5.55 g of sugars, each per 100 g. This has revealed that the calorie and weight of sugars decrease to 23.73% and 15.21% of those of the typical steamed Chinese noodles, respectively.

The dried konjac obtained in Example 2 has a calorie of 181.32 kcal and contains 23.01 g of sugars as shown in Table 2-2. After reconstitution with water to 4 times the original weight as shown in Example 2 of Table 3, the dried konjac has a calorie of 45.33 kcal and contains 5.75 g of sugars, each per 100 g. This has revealed that the calorie and weight of sugars decrease to 22.89% and 15.75% of the typical steamed Chinese noodles, respectively.

The dried konjac obtained in Example 3 has a calorie of 171.29 kcal and contains 16.71 g of sugars as shown in Table 2-3. After reconstitution with water to 3.5 times the original weight as shown in Example 3 of Table 3, the dried konjac has a calorie of 48.94 kcal and contains 4.77 g of sugars, each per 100 g. This has revealed that the calorie and weight of sugars decrease to 24.72% and 13.07% of the typical steamed Chinese noodles, respectively.

The dried konjac obtained in Example 4 has a calorie of 171.54 kcal and contains 18.55 g of sugars as shown in Table 2-4. After reconstitution with water to 3.5 times the original weight as shown in Example 4 of Table 3, the dried konjac has a calorie of 49.01 kcal and contains 5.3 g of sugars, each per 100 g. This has revealed that the calorie and weight of sugars decrease to 24.75% and 14.52% of the typical steamed Chinese noodles, respectively.

### Referential Example 1

The commercially available rice-like dried konjac has a calorie of 344 kcal and contains 81.6 g of sugars, each per 100 g. Since it is taken after reconstitution with water to 5 times the original weight, the calorie and weight of sugars when it is taken are 68.8 kcal and 16.32 g, each per 100 g, respectively.

It is compared with the processed food of the present invention. The dried konjac of Example 1 has a calorie of 187.9 kcal and contains 22.2 g of sugars as shown in Table 2-1. It is reconstituted with water to 4 times the original weight as described in Example 1 of Table 3 so that after reconstitution with water, the calorie is 46.98 kcal and weight of sugars is 5.55 g, each per 100 g. This has revealed that the calorie and weight of sugars reduce to 68.28% and 34.01% of those of the commercially available rice-like dried konjac.

The dried konjac of Example 2 has a calorie of 181.32 kcal and contains 23.01 g of sugars as shown in Table 2-2. It is reconstituted with water to 4 times the original weight as described in Example 2 of Table 3 so that after reconstitution with water, the calorie is 45.33 kcal and the weight of sugars is 5.75 g, each per 100 g. This has revealed that the calorie and weight of sugars decrease to 65.89% and 35.23% of those of the commercially available rice-like dried konjac.

The dried konjac of Example 3 has a calorie of 171.29 kcal and contains 16.71 g of sugars as shown in Table 2-3. It is reconstituted with water to 3.5 times the original weight as described in Example 3 of Table 3 so that after reconstitution with water, the calorie is 48.94 kcal and weight of sugars I is 4.77 g, each per 100 g. This has revealed that the calorie and weight of sugars decrease to 71.13% and 29.23% of those of the commercially available rice-like dried konjac.

The dried konjac of Example 4 has a calorie of 171.54 kcal and contains 18.55 g of sugars as shown in Table 2-4. It is reconstituted with water to 3.5 times the original weight as described in Example 4 of Table 3 so that after reconstitution with water, the calorie is 49.01 kcal and weight of sugars is 5.3 g, each per 100 g. This has revealed that the calorie and weight of sugars decrease to 71.24% and 32.48% of those of the commercially available rice-like dried konjac.

### Referential Example 2

The commercially available konjac powder-containing rice-like dried product has a calorie of 249 kcal and contains 59.25 g of sugars, each per 100 g. It is taken after reconstituted with water to 5 times the original weight so that the calorie and weight of sugars when it is taken are 49.8 kcal and 11.85 g, each per 100 g, respectively.

The above-described rice-like product will next be compared with the processed food of the present invention. The dried konjac of Example 1 has a calorie of 187.9 kcal and contains 22.2 g of sugars as shown in Example 1 of Table 2-1. It is reconstituted with water to 4 times the original weight as described in Example 1 of Table 3 so that after reconstitution with water, the calorie is 46.98 kcal and the weight of sugars is 5.55 g, each per 100 g. This has revealed that the calorie and the weight of sugars decrease to 94.34% and 46.84% of those of the commercially available konjac powder-containing rice-like dried product, respectively.

The dried konjac of Example 2 has a calorie of 181.32 kcal and contains of 23.01 g of sugars. It is reconstituted with water to 4 times the original weight as described in Example 2 of Table 3 so that after reconstitution with water, the calorie is 45.33 kcal and the weight of sugars is 5.75 g, each per 100 g. This has revealed the calorie and the weight of sugars decrease to 91.02% and 48.52% of those of the commercially available konjac powder-containing rice-like dried product, respectively.

The dried konjac of Example 3 has a calorie of 171.29 kcal and contains 16.71 g of sugars as shown in Table 2-3. It is reconstituted with water to 3.5 times the original weight as described in Example 3 of Table 3 so that after reconstitution with water, the calorie is 48.94 kcal and the weight of sugars is 4.77 g, each per 100 g. This has revealed that the calorie and the weight of sugars decrease to 98.27% and 40.25% of those of the commercially available konjac powder-containing rice-like dried product, respectively.

The dried konjac of Example 4 has a calorie of 171.54 kcal and contains 18.55 g of sugars as shown in Table 2-4. It is reconstituted with water to 3.5 times the original weight as described in Example 4 of Table 3 so that after reconstitution with water, the calorie is 49.01 kcal and the weight of sugars is 5.3 g, each per 100 g. This has revealed that the calorie and the weight of sugars decrease to 98.41% and 44.73% of those of the commercially available konjac powder-containing rice-like dried product, respectively.

The dried konjac of the present invention in granular form or powdery form can be used as an alternative of processed livestock foods, processed marine foods, jelly, jam, bean paste products, cream or butter.

The dried konjac of the present invention contains at least 30% of indigestible dextrin, which is expected to produce a blood sugar level suppressing effect. If it is reconstituted with water to 4 times the original weight, the indigestible dextrin content is still at least 7.5%. This means the water-reconstituted dried konjac contains at least 7.5 g of indigestible dextrin per 100 g.

This amount is announced as an amount from which a sufficient blood sugar level suppressing effect can be expected so that it will be an optimum food for diabetic patients or potential diabetic patients.

The relationship between the water reconstitution ratio of dried konjac obtained in each of Examples 1 through 4 and the indigestible dextrin content in the dried konjac reconstituted with water is described in Table 3.

The dried konjac of Example 1 contains 35.5% of indigestible dextrin as shown in Table 2-1. It is reconstituted with water to 4 times the original weight as described in Example 1 of Table 3 so that the dried konjac reconstituted with water has an indigestible dextrin content of 8.88 g per 100 g.

The dried konjac of Example 2 contains 34% of indigestible dextrin as shown in Table 2-2. It is reconstituted with water to 4 times the original weight as described in Example 2 of Table 3 so that the dried konjac reconstituted with water has an indigestible dextrin content of 8.5 g per 100 g.

The dried konjac of Example 3 contains 30% of indigestible dextrin as shown in Table 2-3. It is reconstituted with water to 3.5 times the original weight as described in Example 3 of Table 3 so that the dried konjac reconstituted with water has an indigestible dextrin content of 8.57 g per 100 g.

The dried konjac of Example 4 contains 45% of indigestible dextrin as shown in Table 2-4. It is reconstituted with water to 3.5 times the original weight as described in Example 1 of Table 3 so that the dried konjac reconstituted with water has an indigestible dextrin content of 12.86 g per 100 g.

The dried konjac can be readily reconstituted with water and it does not take much time for reconstitution. It can therefore be used for instant foods such as pot noodle or cup rice which is ready for a few minutes after adding boiling water to the cup. The relationship between the time necessary for reconstitution when the dried konjac obtained in Example 1 is soaked in hot water of 90° C. and the weight thereafter is shown in Table 5. It has been found that five minutes after soaking in hot water of 90° C., the dried konjac is reconstituted to 4 times the original weight and thus, it can restore the original state by the reconstitution with water.

The time required for reconstituting the dried konjac of Example 1 with water and weight (after soaked in hot water of 90° C.) are shown in Table 5.

TABLE 5

| | Before | 1 | 2 | 3 | 4 | 5 |
|---|---|---|---|---|---|---|
| | soaking | minute | minutes | minutes | minutes | 5 minutes |
| Rice-like | 10 g | 28.7 g | 34.2 g | 37.0 g | 40.2 g | 41.0 g |
| dried konjac | | | | | | |
| Noodle-like | 10 g | 28 g | 33.4 g | 36.2 g | 38.4 g | 40.0 g |
| dried konjac | | | | | | |

The dried konjac food is comprised of konjac so that it is stable against heating and pressure and it neither loses its shape nor changes its color. It can also be used for packaged foods such as retort foods which need heating treatment after packaging.

### INDUSTRIAL APPLICABILITY

The dried konjac of the present invention which is a low-calorie and low-sugar food and processed foods using it are widely used as health foods, medical foods such as diet for diabetes, and various other foods.

1-2. (canceled)

3. A processed food wherein the processed food is a rice-like food comprising the component as claimed in claim 8.

4. A processed food wherein the processed food is a noodle-like food comprising the component as claimed in claim 8.

5. A processed food wherein the processed food is obtained by adding a granular or powdery ground product comprising, as one component thereof, the dried konjac as claimed in claim 8.

6. A processed food wherein the processed food is an instant food having, as one component thereof, the dried konjac as claimed in claim 8.

7. A processed food wherein the processed food is a retort food having, as one component thereof, the dried konjac as claimed in claim 8.

8. Dried konjac comprising, ratio by weight, from 8 to 20% of at least one starch material selected from tapioca, potato, corn starch, and processed starch, from 6 to 20% of konjac powder, from 15 to 40% of at least one dietary fiber material selected from a dietary fiber material group A including indigestible starches and processed starches containing dietary fibers, from 0 to 10% of at least one dietary fiber material selected from a dietary fiber material group B including oat fiber, wheat fiber, potato fiber, sugarcane fiber, crystalline cellulose, sodium alginate, carrageenan, guar gum, hydrolyzed guar gum, psyllium seed gum, xanthan gum, tamarind gum, tragacanth gum, and Gellan gum, and from 30 to 50% of indigestible dextrin.

9. A method of manufacturing dried konjac as claimed in claim 1, comprising a step of preparing a konjac starch by using from 1.6 to 4.0% of at least one starch material selected from tapioca, potato, corn starch, and processed starch, from 1.2 to 4.0% of konjac powder, from 3.0 to 8.0% of at least one dietary fiber material selected from a dietary fiber material group A including indigestible starches and processed starches containing dietary fibers, from 0 to 2.0% of at least one dietary fiber material selected from a dietary fiber material group B including oat fiber, wheat fiber, potato fiber, sugarcane fiber, crystalline cellulose, sodium alginate, carrageenan, guar gum, hydrolyzed guar gum, psyllium seed gum, xanthan gum, tamarind gum, tragacanth gum, and Gellan gum and from 82.0 to 94.2% of water, a step of gelling the konjac starch while adjusting the water temperature to not greater than the gelatinization temperature of the starch, that is, not greater than 60° C., a step of steaming the konjac gel at 70° C. or greater and gelatinizing the starch in the konjac gel in a water unsaturated state without increasing a water content of the konjac gel, and a step of adding from 5 to 20%, based on the konjac gel; of indigestible dextrin to the konjac gel; mixing to discharge the water from the konjac gel; and a step of drying the konjac gel containing the said amount of indigestible dextrin.
